(19) United States
(12) Patent Application Publication
(10) Pub. No.: US 2013/0144662 A1
(43) Pub. Date: Jun. 6, 2013

(54) SYSTEM AND METHOD FOR VIEWING AND PURCHASING REMOTELY ACCESSIBLE PURCHASABLE ITEMS IN OR ON DISPLAYS GENERATED BY A HOST APPLICATION

(71) Applicant: Seatwave Limited, London (GB)

(72) Inventor: Gerard Dennis Waring, London (GB)

(73) Assignee: SEATWAVE LIMITED, London (GB)

(21) Appl. No.: 13/685,129

(22) Filed: Nov. 26, 2012

Related U.S. Application Data
(60) Provisional application No. 61/567,067, filed on Dec. 5, 2011.

(51) Int. Cl. G06Q 30/06

(52) U.S. Cl. CPC G06Q 30/0641
USPC 705/5; 705/27.1

(57) ABSTRACT

Systems and methods enable users to browse purchasable items and conduct payment and purchasing transactions within the a single UI environment of a host application, without navigating to a separate application to complete the transaction. Purchase of purchasable items can be implemented using a computing device. A first user interface can be generated, including purchasable item listings. The purchasable item listings can be received by the computing device. A single host application displays the first user interface including the purchasable item listings on a display. A second user interface based at least in part on a user selection can be generated including a purchase and/or payment web page. The purchase and/or payment web page can be received by the computing device. The single host application can display the second user interface, as well. A payment transaction can proceed based on purchase information input into the one or more input fields.

### RELATED APPLICATION

This application claims priority to, and the benefit of, co-pending U.S. Provisional Application No. 61/567,067, filed Dec. 5, 2011, for all subject matter common to both applications. The disclosure of said provisional application is hereby incorporated by reference in its entirety.

### FIELD OF THE INVENTION

The present invention relates to purchase and payment transactions on user devices. More particularly, the present invention relates to systems and methods for presenting and enabling transactions involving purchasable items within a host application's user interface (UI) environment.

### BACKGROUND OF THE INVENTION

In purchase and payment transactions performed with a user device (e.g., a smart phone device), and within a host application, users are often required to navigate away from the user interface (UI) environment of a host application and onto one or more user interfaces provided by a different, separately running application. For example, on a smart phone device, a shopping application may present a user with an opportunity to purchase one or more shopping products (e.g., shoes). The purchase opportunity may be displayed to the user in the form of a selectable link that when clicked by the user launches a browser application and directs the browser application to a third-party purchase and/or payment web page.

Such purchase and payment processes can result in low retention of interested buyers. Many users immediately close out of a browser application as soon as it launches, and before it has had an opportunity to load the payment and/or purchase web page. Such systems often do not provide a way to easily and conveniently return to the host application. This discourages purchases by users who want to continue using the host application after making a purchase.

Accordingly, users presently are unable to either access valuable information about items for sale (herein referred to as “purchasable items”) or conduct a payment transaction on their user devices without first launching a separate client application and loading a separate web page displaying the requested information.

### SUMMARY

There is a need for computer implemented systems and methods enabling users to both gain access to valuable information and conduct a payment transaction for a purchasable item within a host application's UI environment on a user device. The present invention is directed toward solutions to address this need, in addition to having other desirable characteristics that will be appreciated by one of skill in the art upon reading the present specification.

According to example embodiments of the present invention, a non-transitory computer readable storage device contains instructions stored thereon that, when executed, cause at least one processor of a computing device to perform a method for enabling purchase of one or more purchasable items. The method can include causing an operating system of the computing device to generate a first user interface that includes one or more purchasable item listings. The one or more purchasable item listings can be received by the computing device from a first remote source. A single host application stored on the computing device can be caused to display the first user interface that includes the one or more purchasable item listings on at least one display on at least one presentation component. A second user interface based at least in part on a user selection of one of the one or more purchasable item listings can be generated that includes a purchase and/or payment web page having one or more input fields, the purchase and/or payment web page being received by the computing device from a second remote source. The single host application stored on the computing device can be caused to display the second user interface that includes the purchase and/or payment web page on at least one display on the at least one presentation component. A payment transaction can be caused to proceed based on purchase and/or payment information input into the one or more input fields.

According to aspects of the present invention, the method can include modifying the first user interface based on one or more display presets prior to causing the single host application to display the first user interface. The single host application stored on the computing device can be caused to generate and display a plurality of additional user interfaces each including one or more purchasable item listings. The plurality of additional user interfaces can progressively narrow the one or more purchasable item listings based on sub-categories. The payment transaction can be successfully completed automatically if one or more transaction requirements are met. The one or more purchasable item listings can be caused to be received by the computing device from the first remote source. Causing the operating system of the computing device to generate the first user interface that includes one or more purchasable item listings can include causing one or more views native to the operating system to generate the first user interface, generating one or more pointers to the first user interface, and providing the one or more pointers to the host application. Causing the operating system of the computing device to generate the first user interface can include one or more purchasable item listings can include causing one or more views native to the operating system to generate the first user interface, generating one or more pointers to the first user interface, and making one or more callbacks to the host application. The one or more callbacks can include the one or more pointers. The first user interface can be modified based on one or more display presets in the one or more callbacks. The host application can enable one or more functions that are different from enabling purchase of one or more purchasable items.

According to aspects of the present invention, the method can include causing the purchase and/or payment web page to be received by the computing device from the second remote source. One or more responses can be provided based on user input received as a result of a user interacting with the second user interface. Providing one or more responses based on user input received as a result of a user interacting with the second user interface can include: (a) receiving input; (b) generating a dummy script based on the received input; (c) providing the dummy script to one or more native views, thereby causing the one or more native views to generate an additional user interface that includes one or more predetermined messages; and (d) causing the host application to display the additional user interface that includes the one or more predetermined messages on the at least one display on the at least one presentation component. The input can include input received as a result of user interaction, input received as a result of one or more web pages being loaded, input received as a result of the payment transaction being successfully completed, or input received as a result of the payment transaction failing to be successfully completed. Furthermore, providing one or more responses based on user input received as a result of a user interacting with the second user interface can include: (a) receiving input; (b) converting the received input into a format intelligible to the host application; and (c) providing the host application with the received input in the format intelligible to the host application. Providing the host application with the received input in the format intelligible to the host application can include making one or more callbacks to the host application, and the one or more callbacks can contain the received input in the format intelligible to the host application.

According to aspects of the present invention, causing the payment transaction to proceed can include causing the purchase and/or payment information to be output through at least one output device to a remote source configured to conduct the payment transaction. The method further can include causing a confirmation display to be presented based on an indication received from a remote source that the payment transaction was successfully completed. One or more indications that a transaction was completed can be caused to be output through at least one output device to an affiliated third-party revenue tracking service. The first remote source, the second remote source, or both can include one or more remote databases. The first remote source and the second remote source can be the same or different. Each of the one or more purchasable item listings can represent one or more purchasable items stored in one or more remote databases. The one or more remote databases can be updated periodically or in real time. Each of the one or more purchasable item listings can represent one or more purchasable items based on information that is associated on the first remote source with the one or more purchasable items. Each of the one or more purchasable item listings can represent one or more purchasable tickets. The one or more purchasable tickets can include one or more of a purchasable event ticket, a purchasable concert ticket, a purchasable sports ticket, a purchasable theatre ticket, or a purchasable festival ticket.

According to example embodiments of the present invention, a computer-implemented method for enabling purchase of one or more purchasable items on a computing device can include causing, using one or more processors, an operating system of the computing device to generate a first user interface that includes one or more purchasable item listings. The one or more purchasable item listings can be received through at least one input device by the computing device from a first remote source. Using one or more processors, a single host application stored on the computing device can be caused to display the first user interface that includes the one or more purchasable item listings on at least one display on at least one presentation component. Using one or more processors, and based at least in part on a user selection of one of the one or more purchasable item listings, a second user interface can be generated that includes a purchase and/or payment web page having one or more input fields, the purchase and/or payment web page being received through at least one output device by the computing device from a second remote source. Using one or more processors, the single host application stored on the computing device can be caused to display the second user interface that includes the purchase and/or payment web page on at least one display on the at least one presentation component. Using one or more processors, a payment transaction can be caused to proceed based on purchase and/or payment information input into the one or more input fields. The one or more purchasable item listings can be received through the at least one input device from a first remote source. The first user interface that includes one or more purchasable item listings can be displayed on the at least one presentation component. The second user interface that includes the purchase and/or payment web page can be displayed on the at least one presentation component. Using one or more processors, the first user interface can be modified based on one or more display presets prior to causing the single host application to display the first user interface. Using one or more processors, the single host application stored on the computing device can be caused to generate and display a plurality of additional user interfaces each including one or more purchasable item listings. The plurality of additional user interfaces can progressively narrow the one or more purchasable item listings based on sub-categories. The payment transaction automatically can be successfully completed if one or more transaction requirements are met.

According to aspects of the present invention, using one or more processors, the one or more purchasable item listings can be caused to be received by the computing device from the first remote source. Causing the operating system of the computing device to generate the first user interface that includes one or more purchasable item listings can include causing one or more views native to the operating system to generate the first user interface, generating one or more pointers to the first user interface, and providing the one or more pointers to the host application. Causing the operating system of the computing device to generate the first user interface that includes one or more purchasable item listings can include causing one or more views native to the operating system to generate the first user interface, generating one or more pointers to the first user interface, and making one or more callbacks to the host application. The one or more callbacks can include the one or more pointers. Using one or more processors, the first user interface can be modified based on one or more display presets in the one or more callbacks. The host application can enable one or more functions that are different from enabling purchase of one or more purchasable items.

According to aspects of the present invention, using one or more processors, the purchase and/or payment web page can be caused to be received by the computing device from the second remote source. One or more responses can be provided based on user input received as a result of a user interacting with the second user interface. Providing the one or more responses based on user input received as a result of a user interacting with the second user interface can include: (a) receiving input; (b) generating a dummy script based on the received input; (c) providing the dummy script to one or more native views, thereby causing the one or more native views to generate an additional user interface that includes one or more predetermined messages; and (d) causing the host application to display the additional user interface that includes the one or more predetermined messages on the at least one display on the at least one presentation component. The input can include input received as a result of user interaction, input received as a result of one or more web pages being to loaded, input received as a result of the payment transaction being successfully completed, or input received as a result of the payment transaction failing to be successfully completed. Providing the one or more responses based on user input received as a result of a user interacting with the second user interface can include: (a) receiving input; (b) converting the received input into a format intelligible to the host application; and (c) providing the host application with the received input in the format intelligible to the host application. Providing the host application with the received input in the format intelligible to the host application can include making one or more callbacks to the host application. The one or more callbacks can contain the received input in the format intelligible to the host application. Causing the payment transaction to proceed can include causing the purchase and/or payment information to be output through at least one output device to a remote source configured to conduct the payment transaction. A confirmation display can be caused to be presented based on an indication received from a remote source that the payment transaction was successfully completed. One or more indications that a transaction was completed can be caused to be output through at least one output device to an affiliated third-party revenue tracking service. The first remote source, the second remote source, or both can include one or more remote databases. The first remote source and the second remote source can be the same or different. Each of the one or more purchasable item listings can represent one or more purchasable items stored in one or more remote databases. The one or more remote databases can be updated periodically or in real time. Each of the one or more purchasable item listings can represent one or more purchasable items based on information that is associated on the first remote source with the one or more purchasable items. Each of the one or more purchasable item listings can represent one or more purchasable tickets. The one or more purchasable tickets can include one or more of a purchasable event ticket, a purchasable concert ticket, a purchasable sports ticket, a purchasable theatre ticket, or a purchasable festival ticket.

According to example embodiments of the present invention, a computer-implemented system can include at least one processor, at least one input device, at least one presentation component, and at least one non-transitory computer readable storage device. The at least one non-transitory computer readable storage device can contain instructions stored thereon that, when executed, cause the at least one processor to cause an operating system stored on the at least one non-transitory computer readable storage device to generate a first user interface that includes one or more purchasable item listings. The one or more purchasable item listings can be received from a first remote source through the at least one input device. The instructions can cause the at least one processor to cause a single host application stored on the at least one non-transitory computer readable storage device to display the first user interface that includes the one or more purchasable item listings on at least one display on the at least one presentation component. The instructions can cause the at least one processor to generate, based at least in part on a user selection of one of the one or more purchasable item listings, a second user interface that includes a purchase and/or payment web page having one or more input fields. The purchase and/or payment web page can be received from a second remote source through the at least one input device. The instructions can cause the at least one processor to cause the single host application to display the second user interface that includes the purchase and/or payment web page on at least one display on the at least one presentation component. The instructions can cause the at least one processor to cause a payment transaction to proceed based on purchase and/or payment information input into the one or more input fields.

### BRIEF DESCRIPTION OF THE FIGURES

These and other characteristics of the present invention will be more fully understood with reference to the following detailed description in conjunction with the attached drawings, in which:

FIG. 1 is a diagrammatic illustration of a user device and a remote computing system, according to example embodiments of the present invention;

FIG. 2 is a diagrammatic illustration of model-view-controller (MVC) architecture for implementing example embodiments of the present invention;

FIG. 3 is an example method for causing one or more purchasable item listings to be displayed, according to aspects of the present invention;

FIG. 4 is an example method for performing steps 104 through 110 of FIG. 3 using the MVC architecture of FIG. 2, according to example embodiments of the present invention;

FIG. 5 is an example method for enabling a user to conduct a payment transaction within a UI environment of a host application, according to aspects of the present invention;

FIG. 6 is an example method for providing one or more additional notification features, according to aspects of the present invention;

FIG. 7 is an example method of automatically enabling a revenue service to track purchases and payments for divvying up generated revenues, according to one aspect of the present invention;

FIG. 8 is an example method of browsing purchasable item listings and successfully completing a payment transaction from the perspective of a user, according to aspects of the present invention; and

FIG. 9 is an example computing device for implementing the user device or the remote computing system of FIG. 1, according to one aspect of the present invention.

### DETAILED DESCRIPTION

An illustrative embodiment of the present invention relates to systems and methods for allowing users to browse purchasable items and conduct payment and purchasing transactions, all within the UI environment of a host application. In the example embodiments described herein, a user is enabled to use a host application to browse a continuously or periodically updating inventory of purchasable items maintained in a source that is remote from the user device (e.g., a remote database on a web server). The purchasable items can be presented in/or one or more displays generated by the host application, thereby enabling users to browse purchasable items in the remote source (e.g., database) without leaving the displays of the host application. Furthermore, once the user has sufficiently browsed the listings and determined to purchase one or more of the represented purchasable items, the user is enabled to do so without leaving the UI environment of the host application. For example, the host application can use one or more additional tools to receive (from a remote source) one or more purchase and/or payment web pages, which then can be rendered by the additional tools and included in/on one or more displays being generated by the host application.

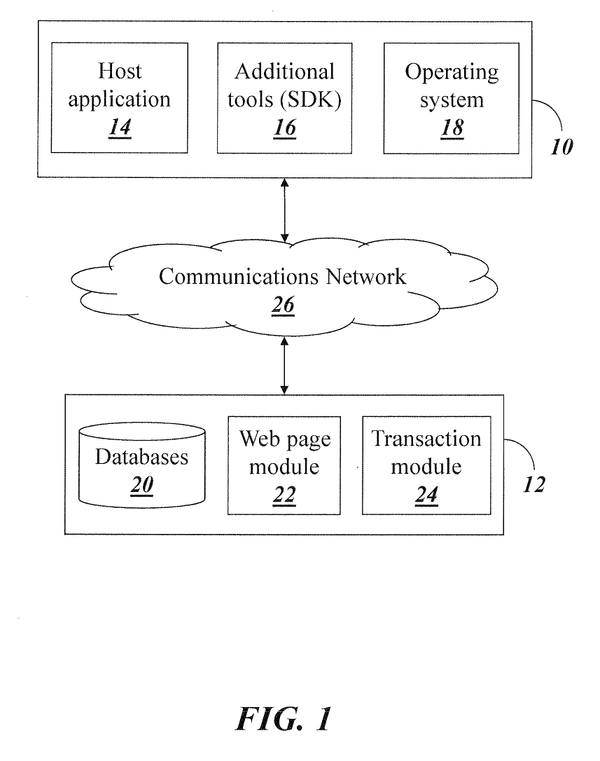

FIGS. 1 through 9, wherein like parts are designated by like reference numerals throughout, illustrate example embodiments of systems and methods for enabling purchase and payment of purchasable items within a user interface environment of a host application, according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, such as the size, shape, or type of elements or materials, in a manner still in keeping with the spirit and scope of the present invention.

FIG. 1 depicts an example user device 10 and a remote computing system 12 for performing various functions and methods of embodiments of the present invention described herein. The user device 10 generally includes a host application 14 (e.g., in the form of executable code) and one or more additional tools 16 (e.g., programming tools, libraries, APIs, other software development kit tools, and the like) that support the host application 14 in one or more of its functions. The user device 10 also includes an operating system 18, on which the host application 14 and the additional tools 16 operate. Accordingly, the operating system 18 is at a lower level software layer than the host application 14, and can be called by the host application 14 using the additional tools 16, e.g., to perform one or more subroutines that enable one or more functions described herein.

The additional tools 16 can support any number of different functions, including the following illustrative and non-limiting examples: (a) rending and customizing views native to the operating system 18 of the user device 10, (b) enabling communication (e.g., information retrieval) between the user device 10 and the remote computing system 12, (c) rendering web pages stored on the remote computing system 12, and many other functions, as described in detail herein.

In an illustrative embodiment, the additional tools 16 are provided by a software development kit (SDK), as would be appreciated by one of skill in the art upon reading the present specification. For example, the additional tools 16 (e.g., SDK) can be provided to a developer of the host application 14 by the remote computing system 12. In one embodiment, the additional tools 16 (e.g., SDK) are provided as executable instructions that are downloadable in a precompiled format from a web page provided by the remote computing system 12, and which can be incorporated into the host application 14 (e.g., as a precompiled header for inclusion in the source code of the host application 14). In illustrative embodiments, the remote computing system 12 is a system for implementing and enabling the purchase and payment of one or more purchasable items (e.g., ticket sales).

The host application 14 can be provided by a third party that is different and distinct from the party providing the remote computing system 12, according to one illustrative example embodiment of the present invention. Furthermore, the host application 14 can have one or more primary features that provide different functions from purchase of items. In this manner, the additional tools 16 can act as an add-on to enable additional purchase features for users of the host application 14. Notably, in the illustrative embodiments described herein, the additional purchase features are provided entirely within the user interface environment of the host application 14. As one non-limiting example, the host application 14 can be a music playback application. When provided with the additional tools 16, the host application 14 can support one or more purchase and payment functions, e.g., which can enable users of the host application 14 to view tickets of an artist currently being played by the host application 14 and to purchase one or more of the viewed tickets from the remote computing system 12, without leaving the displays of the host application 14.

The remote computing system 12 can include one or more databases 20, which can store a plurality of information pertaining to purchasable items (e.g., tickets, ticket prices, venue information, seating charts, other purchasable goods or services, and any other relevant information). Specifically, the one or more databases 20 can include a continuously updating inventory of available purchasable items. For example, the one or more databases 20 can include a listing of purchasable concert tickets, which updates continuously to reflect unavailability once a concert ticket has been sold. The remote computing system 12 further can include a web page module 22 configured to select, transmit, and process information pertaining to particular web pages from the one or more databases 20. For example, the web page module 22 can receive and process information transmitted from the user device 10 and contained in one or more web pages. The remote computing system 12 also can include a transaction module 24 configured to conduct secure payment transactions, e.g., through secure communication with one or more banking institutions, payment account managers, etc. All of the various components of the remote computing system 12 can be logically connected and in communication with one another. The user device 10 and the remote computing system 12 can be in communication with one another via a connection to a communications network 26 (e.g., the Internet).

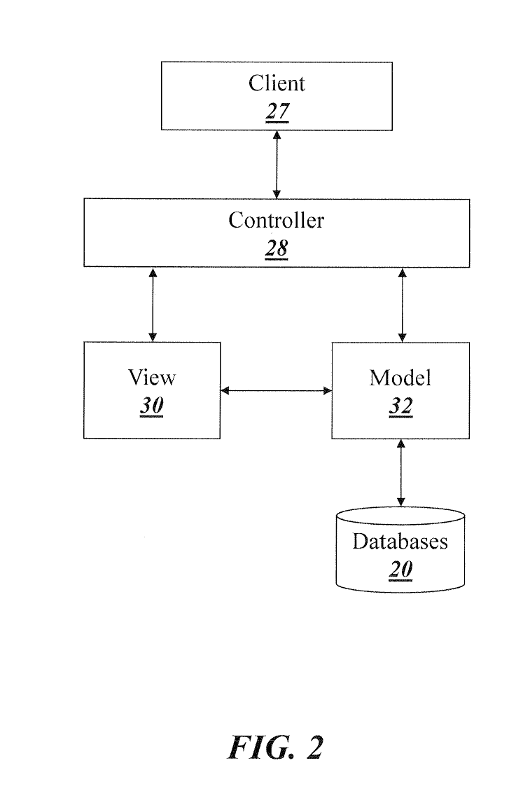

The user device 10 can be implemented using conventional model-view-controller (MVC) software architecture, as would be understood by one of skill in the art. For example, FIG. 2 schematically depicts one illustrative example embodiment of such MVC architecture. The MVC architecture generally includes a client 27, a controller 28, a view 30, and a model 32. The client 27 can be a simple user interface enabling the user to provide desired input into the user device 10. The controller 28 can be a dedicated module for receiving the user input and transforming it into a form intelligible by the model 32. For example, the controller 28 can indicate to the model 32 that a change in state has occurred, thereby requiring the model 32 to update with additional information, e.g., which can be received from the one or more databases 20. The controller 28 furthermore can indicate to the view 30 that a change in state has occurred, thereby causing the view 30 to query the model 32 for information associated with the change in state. The view 30 can transform the information (e.g., retrieved by the model 32) into a user interface (e.g., into one or more user interface components) capable of being displayed by the client 27. The controller 28 thus can respond to the received input by providing the client 27 with the generated user interface.

Accordingly, in illustrative embodiments, the views 30 (e.g., as depicted in FIG. 2) are native to the operating system 18 of the user device 10, as would be appreciated by one of skill in the art. Such views, which are native to the operating system 18 of the user device 10, are herein referred to as “native views.” As one non-limiting example, the native views 30 can be Objective C (e.g., Cocoa) views, or other formats, as would be appreciated by one of skill in the art.

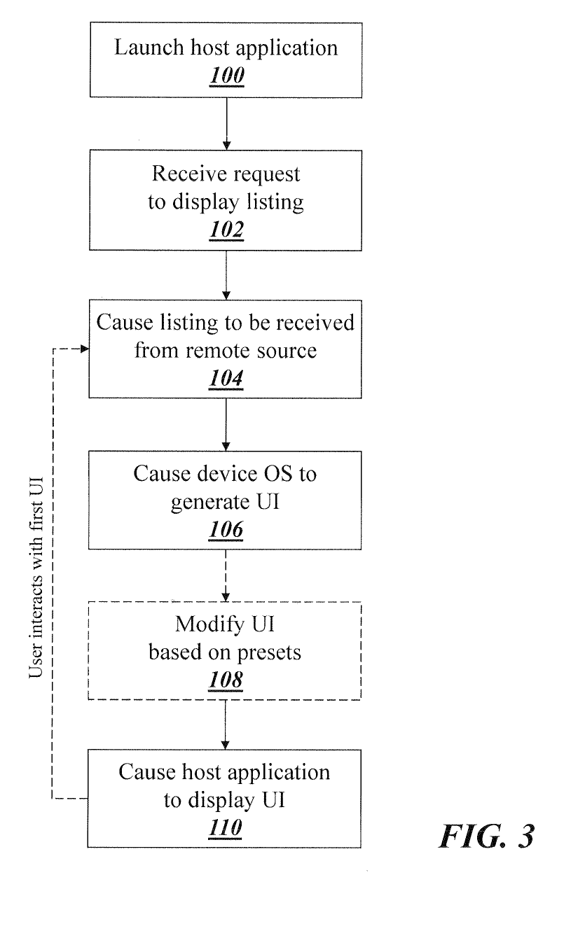

FIG. 3 depicts an example method by which one or more listings of purchasable items can be displayed to a user operating the user device 10. As preliminary steps, the host application 14 can be launched (step 100), e.g., by the operating system 18 in response to a command from the user. Once launched, the user can interact with the host application 14 in any number of intended ways (e.g., music playback, etc.) using functions enabled by the host application 14. At some stage in the user's interaction with the host application 14, the user can provide input into the user device 10 requesting to view one or more purchasable item listings (e.g., concert tickets). As one illustrative and non-limiting example, the user can request information such as by selecting a “View Upcoming Concert Dates” button by touching an appropriate position on a touch screen of a smart phone device. One of skill in the art will appreciate that there are many different and suitable ways to provide such input capability to the user, and that the user may have multiple different requests, such that the present invention is not limited to any specific illustrative example provided herein.

Additionally, in some embodiments, the user request can be category-specific. For example, the user can specify to view all purchasable items falling within one or more particular categories. In illustrative embodiments implemented for concert tickets, the particular category can be any one or more of the following: a particular artist, a particular event, a particular date, a particular geographic location or region, etc. More generally, as yet further non-limiting examples, the particular category can be a particular type of product/service, a particular product/service merchant, or any other category that may involve a purchasable item and a payment transaction. The present invention is not limited to the specific examples provided herein.

Accordingly, the host application 14 can receive the user request to display such a listing (step 102), which can include an indication of a particular category. This can trigger the host application 14 to cause the additional tools 16 to cause at least one processor to perform a series of subsequent steps (e.g., steps 104 through 110) that enable the user to browse one or more listings of purchasable items stored in a remote source (e.g., the remote computing system 12) on/in one or more displays contained within the host application 14.

The additional tools 16 can cause one or more purchasable item listings (i.e., information concerning purchasable items) to be received from a remote source (step 104), such as the remote computing system 12. Step 104 can include the additional tools 16 generating a request for the remote computing system 12 to retrieve one or more purchasable item listings, e.g., pertaining to a desired category. The additional tools 16 can cause the request to be output by the user device 10 through at least one output device. Upon being output, the request can be transmitted across the communications network 26 and received by the remote computing system 12. Based on the received request, the remote computing system 12 can search the one or more databases 20 and retrieve the requested one or more purchasable item listings. The retrieved one or more purchasable item listings can be output by the remote computing system 12 through at least one output device and transmitted across the communications network 26. The one or more purchasable item listings then can be received by the user device 10 through at least one input device.

In response to receiving the one or more purchasable item listings (e.g., pertaining to the particular category), the user device 10 can cause the operating system 18 to generate a user interface (UI) that includes the one or more purchasable item listings (step 106). In some embodiments, the one or more purchasable item listings caused to be received by the user device 10 in step 104 are received in an un-rendered form, and thus requires rendering in order to generate the user interface containing the one or more purchasable item listings. Accordingly, the step 106 can include causing the operating system 18 to render the one or more purchasable item listings to generate the UI. Optionally, the additional tools 16 can modify (e.g., change, add to, remove from, update, etc.) the UI based on one or more presets (step 108), which can be stored on the user device 10. For example, the one or more display presets can include one or more automatic display presets provided by the additional tools 16 and/or one or more customization preferences provided by a developer of the host application 14 (e.g., stored within the host application 14 in a format intelligible to the additional tools 16). Performing the step 108 can be useful in providing the UI with a “look” and a “feel” that matches, conforms to, mimics, or is otherwise visually compatible with one or more displays, windows, etc. being generated by the host application 14 for functions that are different from browsing the list of purchasable items.

The additional tools 16 can cause the host application 14 to display the UI (step 110), e.g., by including the UI in/on one or more displays generated by the host application 14 and output on one or more presentation components (e.g., monitor) on the user device 10. In certain embodiments, the additional tools 16 call one or more subroutines that generate the UI, which is subsequently provided back to the host application 14 in one or more callbacks to the host application 14.

There are many different ways to perform and arrange steps 104 through 110. For example, the additional tools can utilize the native views 30 of the MVC architecture depicted in FIG. 2. In particular, the additional tools 16 can: (a) perform step 104 by causing the model 32 to be updated based on the request received in step to 102, and (b) perform step 106 by causing one or more of the native views 30 to generate the UI (step 112).

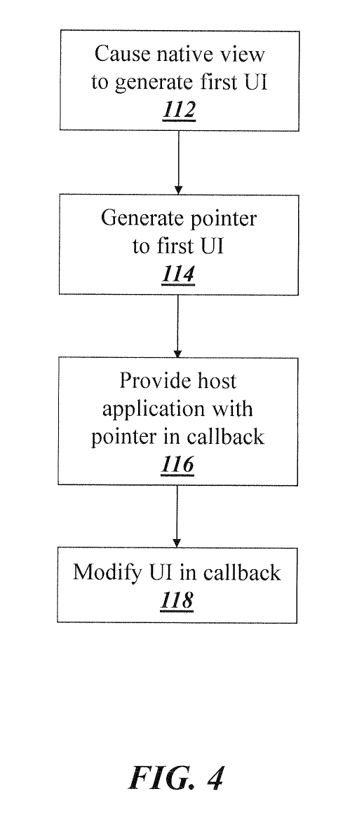

For example, FIG. 4 depicts in greater detail an example method by which steps 104 through 110 can be performed using one or more of the native views 30 using the MVC architecture of FIG. 2. The additional tools 16 use one or more calls to cause the controller 28 to update the model 32 to include the one or more purchasable item listings requested by the user in step 102 (e.g., pertaining to the particular desired category of purchasable items). In response, the controller 28 can cause the model 32 to retrieve the one or more purchasable item listings from the one or more databases 20 by causing a request to be sent to the remote computing system 12 over the communications network 26. This causes the one or more purchasable item listings to be received (thereby completing step 104). Based on the change in the model 32, the native views 30 are caused to render the one or more purchasable item listings and generates the UI.

The additional tools 16 can generate a pointer to the UI (e.g., to one or more UI elements in the native views 30) and can provide the pointer to the host application 14 (step 116). For example, the pointer can be included in one or more callbacks made by the additional tools 16 to the host application 14. Accordingly, in providing the pointer, the host application 14 can be caused to display the UI, thereby completing step 110. Additionally, in making the one or more callbacks, the additional tools 16 optionally can modify the UI based on the one or more presets (step 118), thereby performing step 108.

Each purchasable item listing can include information that identifies or represents one or more purchasable items. For example, in an illustrative embodiment implemented for concert tickets, the purchasable items (e.g., the concert tickets, in this case) are represented in the purchasable item listings according to various pieces of information associated with the one or more tickets. Such associated information can include, as non-limiting examples, any one or more of the following pieces of information: a concert date, a concert time, a concert city, a concert venue, a seating number, and the like. It should be appreciated that in some embodiments, only some such information is presented to the user in the purchasable item listings. For example, in illustrative embodiments implemented for concert tickets, specific seating numbers can be withheld from presentation to the user in the purchasable item listings. Rather, such seating numbers can be presented at a later time, e.g., during a payment process. Accordingly, in some embodiments, each purchasable item listing represents more than one purchasable items (e.g., represents 30 tickets to a particular concert, each of which is associated with a different seating number). In other embodiments, sufficient information is provided to enable each purchasable item listing to represent only one purchasable item. One of skill in the art will appreciate a wide variety of different ways to present the purchasable items to the users in the listings. All such variations and alternatives are contemplated within the scope of the present invention.

In some embodiments, the method of FIG. 3 is repeated one or more times to successively narrow the one or more purchasable item listings. User interaction with the UI caused to be displayed in step 110 can be used as input into step 104, thereby causing steps 104 through 110 to be repeated. For example, each purchasable item listing caused to be displayed in the first iteration of step 110 can be selectable on the UI. Selection of one of these purchasable item listings can cause a new display of purchasable item listings. The newly displayed purchasable item listings can represent fewer purchasable items than the previous display of purchasable item listings. Furthermore, in the new display of purchasable item listings, the purchasable items can be categories according to further sub-categories. In this manner, the purchasable item listings caused to be displayed in step 110 can be selectable to allow successive narrowing of the purchasable items being represented in the display (e.g., according to further sub-categories). Thus, steps 104 through 110 can be repeated until the user has narrowed in on a particular item that the user wishes to purchase. The particular purchasable item that has been iteratively selected by the user for purchase can have any suitable level of specificity or generality. For example, in illustrative embodiments implemented for concert tickets, the purchasable item that the user wishes to purchase can be a ticket to a concert, a ticket to a concert in a particular seating section, a ticket to a concert having a particular seating number, etc.

For example, in such embodiments implemented for concert tickets, the initial to request received in step 102 can be a request to view concert tickets for a particular artist (e.g., Bob Dylan). In step 110, the purchasable items (e.g., the concert tickets, in this example) can be represented in the purchasable item listings as particular concert locations (e.g., cities). Thus, each concert location (e.g., city) displayed in the UI in step 110 represents one or more purchasable tickets for a concert being held by that particular artist in that particular concert location (e.g., city). Upon the user selecting one of the particular displayed concert locations (e.g., cities), steps 104 through 110 can be repeated and the user can be presented in step 110 with particular concert dates. Upon further selection, the tickets can be further narrowed based on venue (e.g., particular theaters, concert halls, restaurants, universities, parks, etc.). Thus, each selection of a particular sub-category results in a smaller subset of purchasable tickets being represented to the user in a further display of purchasable item listings. Accordingly, in this manner, the method of FIG. 3 can be repeated to progressively narrow the number of purchasable items represented by listing (e.g., by allowing the user to select to view only purchasable items falling within one or more subcategories, etc.).

In addition, the steps 104 through 110 also can be used to provide the user with other information pertaining to specific members in the one or more purchasable item listings. For example, continuing with the illustrative example of concert tickets, if the purchasable item listings include particular venues, then the UI additionally can provide the user with an option to browse reviews for the particular listed venues that represent the purchasable items. Accordingly, upon the user selecting one of the venues from the UI, the additional tools 16 cause the reviews to be received from the remote source (step 104). For example, the reviews can be stored in the one or more databases 20 and thus received from the remote computing system 12. Alternatively, the reviews can be received from a different remote source, such as a remote user reviews website (e.g., www.yelp.com, provided by Yelp, Inc. located in San Francisco, Calif.). The additional tools 16 then can cause the operating system 18 to generate a UI (step 106), which is then caused to be displayed to the user by the host application 14 (step 110). In such embodiments where steps 104 through 110 can be repeated (a) to further narrow the purchasable item listings and/or (b) to provide additional information that is unrelated to identifying/representing the purchasable items, the UI further can include one or more navigation buttons (e.g., “Back,” “Forward,” etc.) enabling users to transition between the various UIs that are caused to be displayed in step 110.

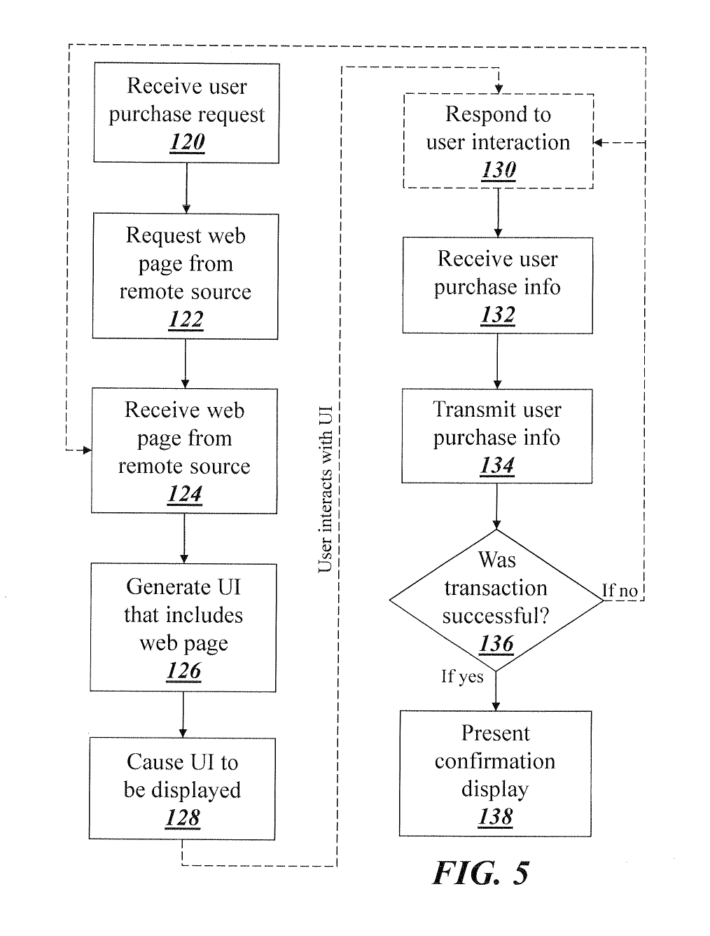

Additionally, the UI caused to be displayed in step 110 can provide the user with the ability to submit a request to the user device 10 to purchase one or more purchasable items represented by one of the displayed purchasable item listings (e.g., after sufficient narrowing by the user through previous selections, as described above). In response, the additional tools 16 can enable the host application 14 to conduct a purchase and payment process on web pages provided by a remote source. For example, FIG. 5 depicts an illustrative method by which the additional tools 16 can enable the host application 14 to conduct a purchase and payment process on web pages provided by a remote source. The user can select one of the one or more purchasable item listings displayed in step 110. As a result, the host application 14 can receive a purchase request (step 120). Based on the received request, the host application 14 can cause the additional tools 16 to cause at least one processor to send a request for one or more purchase and/or payment web pages to a remote source (step 122), such as the remote computing system 12. For example, the step 122 can include the additional tools 16 generating a URL request, causing the user device 10 to output the generated URL request through at least one output device to the remote computing system 12 via the communications network 26. In response to receiving the request, the remote computing system 12 can retrieve the one or more purchase and/or payment web pages (e.g., from the one or more databases 20) and output the one or more web pages through at least one output device, across the communications network 26, and to at least one input device of the user device 10.

Accordingly, the host application 14 can receive the one or more purchase and/or payment web pages from the remote computing system 12 (step 124). The additional tools 16 can use the received purchase and/or payment web pages to generate a user interface (UI) that includes the received purchase and/or payment web pages (step 126). For example, the web pages can be rendered within a browser that is embedded within a native view 30, as would be appreciated by one of skill in the to art. In illustrative embodiments, the one or more purchase and/or payment web pages are received from the remote computing system 12 in an un-rendered form. Thus, the step 126 can include the additional tools 16 rendering the received purchase and/or payment web pages and generating the UI. In addition, the additional tools 16 can cause the UI generated in step 126 to be displayed by the host application 14 (step 128), e.g., in/on one or more displays that are generated by the host application 14 and output on one or more presentation component (e.g., monitor) on the user device 10. For example, the step 128 can include the additional tools 16 generating one or more pointers to the UI (e.g., one or more UI elements) generated by the additional tools 16 in step 126, and further can include the additional tools 16 providing the one or more pointers to the host application 14 in one or more callbacks.

Once the UI is caused to be displayed in step 128, the user can interact with the UI in one or more ways. For example, the received purchase and/or payment web pages can include drop-down menus (e.g., enabling selection of a number of tickets to purchase, etc.), one or more input fields (e.g., enabling the user to enter credit card information, etc.), one or more selectable buttons (e.g., enabling the user to select a payment method, etc.), one or more links (e.g., to additional web pages, to perform functions on other application), and the like. One of skill in the art will appreciate a wide variety of interactions and different types of web pages that can be enabled and provided to the user. In general, the one or more purchase and/or payment web pages received in step 124 can be any web page(s) enabling submission of purchase and payment information in order to perform a payment transaction, as would be appreciated by one of skill in the art. Accordingly, in response to the host application 14 receiving user interaction with the UI, the host application 14 can cause the additional tools 16 to respond in one or more ways (step 130). Notably, the interaction in step 130 can include fetching one or more additional websites from a remote source (e.g., the remote computing system 12), and effectively repeating steps 124 through 128 to present additional web pages to the user, thereby furthering the purchase process.

Accordingly, the UI containing the one or more web pages can be used to gather user purchase and payment information from the user. For example, the UI can include a “submit” button enabling the user to provide purchase and payment information to the host application 14, e.g., through at least one input device (e.g., a touch screen on the user device 10). Accordingly, the host application 14 can receive purchase information from the user (step 132). In response, the host application 14 can cause the additional tools 16 to cause the information to be output through at least one output device to the remote computing system 12 (step 134). The remote computing system 12 can receive the purchase and payment information from the user through at least one input device. Based on the received user purchase and payment information, the transaction module 24 can initiate a transaction payment (step not shown). For example, the transaction module 24 can communicate securely with one or more computerized banking systems to attempt to perform the transaction.

If the initiated transaction is successfully completed in step 136, then the remote computing system 12 can provide an indication of such to the user device 10. The indication can include any variety of transaction information, including (as illustrative and non-limiting examples) transaction number, total cost of transaction (e.g., including commission, postal charges, etc.), purchased items, etc. Once the host application 14 receives the indication from the remote computing system 12 that the transaction was successfully completed, the host application 14 causes the additional tools 16 to present a confirmation display (step 138). On the other hand, if the initiated transaction was not successfully completed in step 136 (e.g., due to insufficient funds, incorrect bank account information, etc.), then the remote computing system 12 can generate a response. For example, in some embodiments, the remote computing system 12 retrieves one or more additional web pages (e.g., which display an error message and highlight an input field that contained faulty information) and sends the one or more additional web pages to the user device 10 (thereby repeating at least steps 124 through 126) to notify the user device that the transaction was not completed. For example, the one or more additional web pages can include input fields for allowing the user to attempt again to submit acceptable payment information.

Alternatively to sending one or more additional web pages to the user device 10 in response to a failed payment transaction, the remote computing system 12 can send an indication to the user device 10 that the attempted transaction failed. The indication can be received by the user device 10 and processed by the additional tools 16 in order to generate a message caused to be displayed, e.g., in/on the UI displayed in step 128. For example, the submission of payment information can be treated as a form of interaction from the user that is processed externally by the remote computing system 12. In such embodiments, the user action (e.g., submission of payment information) is: (a) received from the user through the at least one input device, (b) sent to the remote computing system 12 through at least one output device, (c) processed by the remote computing system 12 (e.g., by attempting and failing to successfully complete a payment transaction), (d) converted into an indication that the payment transaction failed, (f) sent by the remote computing system 12 to the user device 10, and (g) treated as a user interaction with the UI in step 130, e.g., by automatically generating a predetermined response based on the received indication.

Notably, the example method depicted in FIG. 5 can be used to display purchase and/or payment web pages to users of the user device 10 within the UI environment of the host application 14. Thus, users are provided with the ability to browse and purchase purchasable items seamlessly stored and updated (e.g., continuously, periodically, etc.) on a remote source (e.g., the one or more databases 20), all within the displays generated by the host application 14. Said differently, and unlike existing applications, users are not required to leave the UI environment of the host application 14 in order to engage in more browsing or purchase/payment functions. This is contrary to conventional methods and systems, which require viewing and purchasing functionality to occur on a separate application that is distinct from the host application 14. For example, in many existing systems, conventional purchases that are offered to users through a host application 14 (e.g., a game application or a music player application) cannot be completed without launching a separate web browser application (or other client application) and directing to the purchase and/or payment web pages. Accordingly, embodiments of the present invention provide a significant improvement in enabling users to conduct entire browsing, purchase, and payment processes all from UIs generated by the host application 14, e.g., within the UI environment of the host application 14.

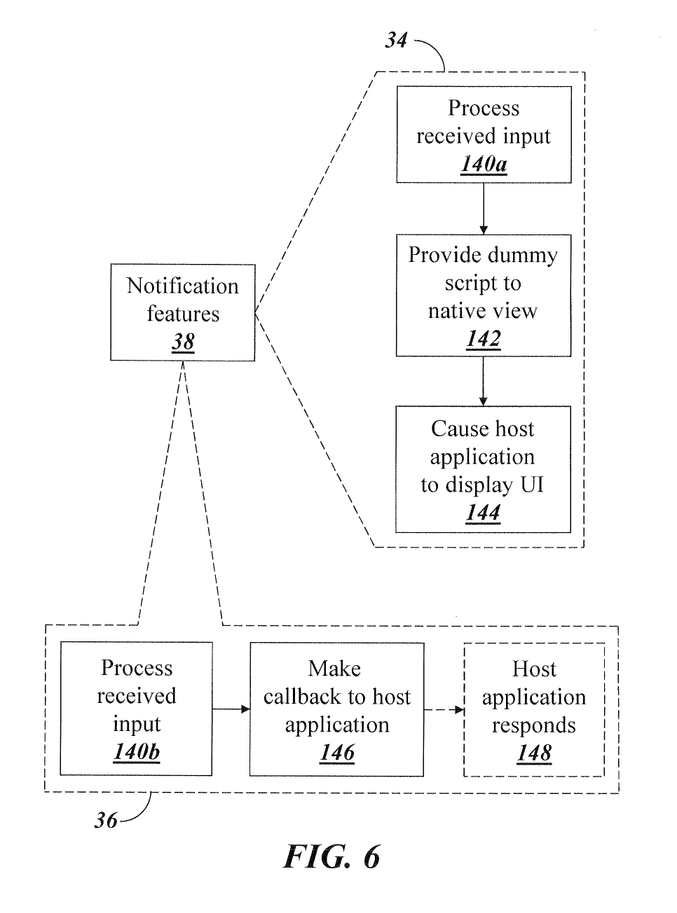

At one or more different stages in the method of FIG. 5, the additional tools 16 can enable further notification features to be provided (e.g., rendered and caused to be presented) by the native views 30, the host application 14, or both. For example, FIG. 6 depicts two illustrative methods 34, 36 by which such notification features 38 can be provided. In one method 34, the additional tools 16 can process received input (step 140a), e.g., to convert the received input into one or more usable formats. As non-limiting examples, the received input can include (a) remote input received in step 124 (e.g., an indication that the web page was transmitted and is currently loading), (b) user input received as a result of the user interacting with the UI caused to be displayed in step 128, (c) remote input received in step 136 (e.g., as a result of the transaction being successfully completed), (d) remote input received in step 130 (e.g., as a results of the transaction failing to successfully complete), or any other suitable input.

In illustrative embodiments, step 140a includes automatically generating a dummy script containing information (e.g., predetermined information) for causing one or more of the native views 30 to automatically generate a UI containing a predetermined notification. The step 140a also can include halting one or more other automated responses to the received input by the user device 10, e.g., to avoid providing multiple similar responses. The dummy script generated in step 140a can be provided to the one or more native views (step 142), thereby causing the one or more native views 30 to automatically generate a user interface containing a message. For example, the one or more native views 30 can be configured to automatically generate a stored, predetermined message as a result of receiving a particular dummy) script in step 142. For example, the logic can be as follows: upon receiving dummy script “A,” generate a display containing a stored, predetermined message. As non-limiting examples, the predetermined message can include a loading message (e.g., “loading page, please wait”), instructional text (“please re-enter credit card number”), etc.

Continuing with FIG. 6, once the dummy script is provided to one or more of the native views 30 in step 142, the additional tools 16 further can cause the host application 14 to present the UI generated by the one or more native views 30 (step 144), e.g., in/on one or more displays generated by the host application 14.

The first method 34 can be used to interrupt functions that direct a user away from the host application 14. In such situations, the first method 34 can provide an alternative response that remains within the UI environment of the host application 14. For example, consider that a purchase and/or payment web page is being displayed and includes a selectable email address that, when clicked, opens a separate email application. In such situations, step 130 can include performing steps 140a through 144. For example, step 140a can include the additional tools 16 (a) causing at least one processor to determine that the use has requested to send an email using the separate email application, (b) interrupting the request so that the user device 10 does not launch the separate email application, and (c) generating a dummy script sufficient to cause one or more native views 30 to generate a native email submission window. Accordingly, in step 142, the generated dummy script can be provided by the additional tools 16 to one or more native views 30. In step 144, the additional tools 16 can cause the host application 14 to display the UI generated by the one or more native views 30 in response to step 142.

Additionally or alternatively to the method 34, the additional tools 16 can cause another method 36 to be performed by at least one processor, which generates one or more additional notification features 38. In the example method 36, the additional tools 16 process the received user input (step 140b). In the step 140b, the additional tools 16 can transform the received user input into a format intelligible by the host application 14. Subsequently, the additional tools 16 can make a callback to the host application 14 containing the transformed user response (step 146). Upon receiving the callback, the host application 14 optionally can respond in one or more predetermined ways dictated by the host application 14 rather than by the additional tools 16 (step 148). As just some non-limiting and illustrative examples, the step 148 can include the host application 14 causing a change in a title of a window or display currently being presented, generating one or more sound alerts, or performing any other response.

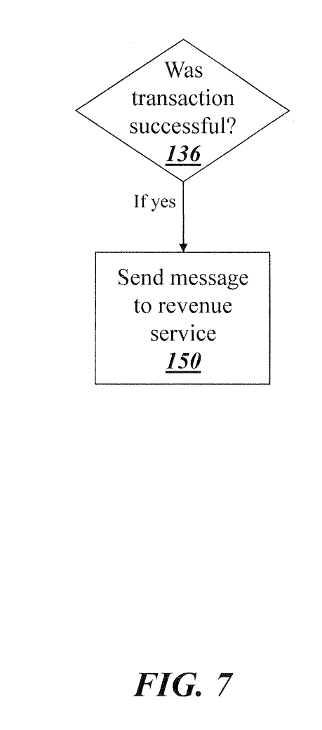

As an additional optional feature, the method of FIG. 5 further can include to providing information to an affiliated third-party revenue tracking service (step 150), as depicted in FIG. 7. For example, the affiliated third-party revenue tracking service can be any conventional service for allocation of profits among multiple parties based on an existing agreement. In illustrative embodiments, the step 150 is performed by the user device 10 upon receiving confirmation from the remote computing system 12 that the transaction was successful. In alternative embodiments, the step 150 can be performed by the remote computing system 12 upon confirming that the transaction was successful.

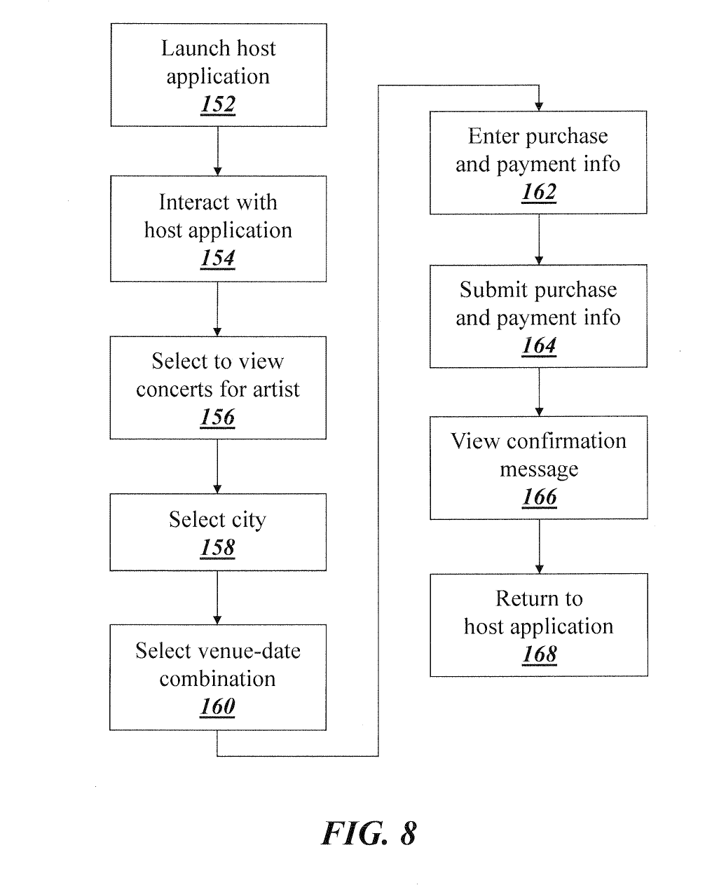

An example of a purchasable item selection and subsequent payment transaction will now be described with reference to FIG. 8 from the perspective of a user operating the user device 10, as can be implemented in illustrative embodiments for concert tickets. The user launches the host application 14 (step 152) and begins interacting with the host application 14 (step 154). For example, the interaction can include the user creating a play list, playing the play list, etc. At some stage during the interaction, the user can select to view concert listings for a particular artist (step 156). The host application 14 receives this information and subsequently utilizes the additional tools 16 to perform steps 104 through 110. Accordingly, subsequent to performing step 156, the user is presented with a plurality of purchasable item listings.

In this example embodiment, the purchasable item listings are initially presented based on city, then subsequently based on a venue-date combination. Thus, the user first selects a particular city (step 158) for which the user is interested in browsing tickets. Next, the user selects a particular venue-date combination for which the user wishes to purchase one or more tickets (step 160). This triggers steps 124 through 128 of FIG. 5. Accordingly, upon selecting a particular venue-date combination, the user may first be provided with a window that states: “Loading. Please wait.” Subsequently, the user may be presented with a purchase and/or payment web page included in/on the display of the host application 14, but provided by the remote computing system 12. Accordingly, the user can enter purchase and payment information (step 162) and submit the entered information (step 164). This triggers steps 132 through 136 of FIG. 5. Assuming that the transaction was successful, the user is presented with a confirmation page (step 166). Subsequently, the user is enabled to return to the host application (step 168), e.g. to continue creating play lists, playing back music, etc.

Illustrative embodiments of the present invention have been described herein with respect to the purchase of concert tickets. However, the present invention is in no way limited to the specific example of concert ticket sales. Similarly, embodiments of the present invention can be utilized in a wide variety of host applications 14 besides those designed for music playback. One of skill in the art will appreciate a wide variety of different ways to implement embodiments of the present invention for many other types and instances of purchases and sales upon reading the present specification.

The user device 10 and the remote computing system 12 can be implemented by any suitable computing device. For example, the user device 10 can be implemented by (as non-limiting examples) a smart phone device, a mobile device, a handheld device, a tablet computer, and any other suitable computing device. Furthermore, the remote computing system 12 can be implemented by one or more server devices, e.g., logically coupled and in communication with each other, or any other suitable computing device. Accordingly, it should be appreciated that the modules, applications, operating systems, and tools of FIG. 1 generally can be implemented as executable instructions (e.g., “code”) contained in one or more non-transitory computer readable storage devices included in the computing device(s).

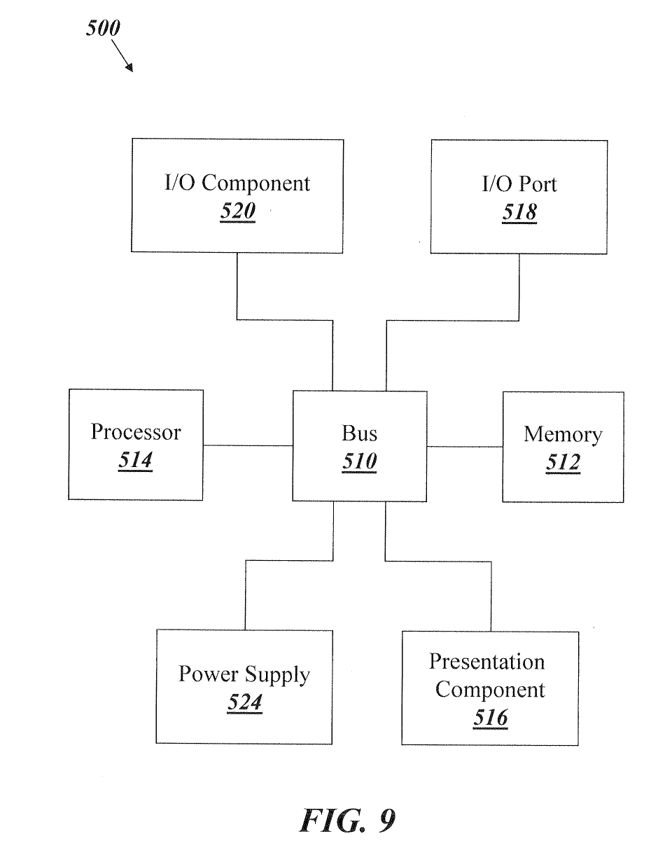

FIG. 9 illustrates one example of a computing device 500 for implementing illustrative methods, systems, and devices of the present invention. It should be appreciated that the computing device 500 is merely an illustrative example of a suitable computing environment and in no way limits the scope of the present invention. In general, a “computing device,” as represented by FIG. 9 and described herein, can include a “workstation,” a “server” (e.g., web server, etc.), a “laptop,” a “desktop,” a “hand-held device,” a “mobile device,” a “smart phone device,” a “tablet computer,” a set-top box, or other computing devices, as would be understood by those of skill in the art. Given that the computing device 500 is depicted for to illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 524. One of skill in the art will appreciate that the bus 510 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 9 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 may be removable, non-removable, or any combination thereof. Exemplary hardware devices are devices such as hard drives, solid-state memory, optical-disc drives, and the like. The computing device 500 can include one or more processors that read data from components such as the memory 512, the various I/O components 516, etc. Presentation component(s) 516 present data indications to a user or other device. Exemplary presentation components include a display device, speaker, printing component, vibrating component, etc.

The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, networking device, and the like.

One of skill in the art will appreciate a wide variety of ways to modify and alter the user device 10 and/or remote computing system 12 of FIG. 1, as well as various other components with which they may interact. For example, the one or more databases 20 can be implemented according to any number of suitable database structures and across any suitable number of databases. Furthermore, some or all of the information contained in the one or more databases 20 alternatively can be stored in another database (e.g., a cloud database) that is communication with the remote computing system 12 via the communications network 26.

Although the components of FIG. 1 are depicted as discrete blocks and elements, it will be appreciated by one of skill in the art that embodiments of the present invention may be implemented in such a way that the depicted applications, operating systems, tools, and modules form fewer or more blocks than are depicted in FIG. 1. Furthermore, while some modules and components are depicted as included within the user device 10 or the remote computing system 12, it should be understood that, in fact, some of the depicted modules alternatively can be excluded therefrom and instead included in a different device, system, etc. One of skill in the art will appreciate a variety of other ways to expand, reduce, or otherwise modify the user device 10 and/or the remote computing system 12 upon reading the present specification.

Using embodiments of the present invention, the described purchase and payment features and functions can be easily included and integrated into any number of different host applications 14. This can enable many different companies, developers, etc. to utilize the additional tools 16 as a supplement to their own desired functionality. Furthermore, the additional tools 16 enable users both to (a) browse purchasable item listings and (b) conduct payment transactions within the UI environment of the host application 14. Enabling users to browse purchasable items, select an item to purchase, and complete the payment transaction without leaving the host application 14 improves the likelihood of users following through on such purchases.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A non-transitory computer readable storage device containing instructions stored thereon that, when executed, cause at least one processor of a computing device to perform a method for enabling purchase of one or more purchasable items, the method comprising:
causing an operating system of the computing device to generate a first user interface comprising one or more purchasable item listings, the one or more purchasable item listings being received by the computing device from a first remote source;
causing a single host application stored on the computing device to display the first user interface comprising the one or more purchasable item listings on at least one display on at least one presentation component;
generating, based at least in part on a user selection of one of the one or more purchasable item listings, a second user interface comprising a purchase and/or payment web page having one or more input fields, the purchase and/or payment web page being received by the computing device from a second remote source;
causing the single host application stored on the computing device to display the second user interface comprising the purchase and/or payment web page on at least one display on the at least one presentation component; and
causing a payment transaction to proceed based on purchase and/or payment information input into the one or more input fields.

2. The device of claim 1, further wherein the method comprises modifying the first user interface based on one or more display presets prior to causing the single host application to display the first user interface.

3. The device of claim 1, further wherein the method comprises causing the single host application stored on the computing device to generate and display a plurality of additional user interfaces each comprising one or more purchasable item listings.

4. The device of claim 3, further wherein the plurality of additional user interfaces progressively narrow the one or more purchasable item listings based on sub-categories.

5. The device of claim 1, further wherein the payment transaction automatically is successfully completed if one or more transaction requirements are met.

6. The device of claim 1, further wherein the method comprises causing the one or more purchasable item listings to be received by the computing device from the first remote source.

7. The device of claim 1, wherein causing the operating system of the computing device to generate the first user interface comprising one or more purchasable item listings comprises causing one or more views native to the operating system to generate the first user interface, generating one or more pointers to the first user interface, and providing the one or more pointers to the host application.

8. The device of claim 1, wherein causing the operating system of the computing device to generate the first user interface comprising one or more purchasable item listings comprises causing one or more views native to the operating system to generate the first user interface, generating one or more pointers to the first user interface, and making one or more callbacks to the host application, the one or more callbacks comprising the one or more pointers.

9. The device of claim 8, further wherein the method comprises modifying the first user interface based on one or more display presets in the one or more callbacks.

10. The device of claim 1, further wherein the host application enables one or more functions that are different from enabling purchase of one or more purchasable items.

11. The device of claim 1, further wherein the method comprises causing the purchase and/or payment web page to be received by the computing device from the second remote source.

12. The device of claim 1, further wherein the method comprises providing one or more responses based on user input received as a result of a user interacting with the second user interface.

13. The device of claim 12, further wherein providing the one or more responses based on user input received as a result of a user interacting with the second user interface comprises:
receiving input;
generating a dummy script based on the received input;
providing the dummy script to one or more native views, thereby causing the one or more native views to generate an additional user interface comprising one or more predetermined messages; and
causing the host application to display the additional user interface comprising the one or more predetermined messages on the at least one display on the at least one presentation component.

14. The device of claim 13, wherein the input comprises input received as a result of user interaction, input received as a result of one or more web pages being loaded, input received as a result of the payment transaction being successfully completed, or input received as a result of the payment transaction failing to be successfully completed.

15. The device of claim 12, further wherein providing the one or more responses based on user input received as a result of a user interacting with the second user interface comprises:
receiving input;
converting the received input into a format intelligible to the host application; and
providing the host application with the received input in the format intelligible to the host application.

16. The device of claim 15, further wherein providing the host application with the received input in the format intelligible to the host application comprises making one or more callbacks to the host application, the one or more callbacks containing the received input in the format intelligible to the host application.

17. The device of claim 1, wherein causing the payment transaction to proceed comprises causing the purchase and/or payment information to be output through at least one output device to a remote source configured to conduct the payment transaction.

18. The device of claim 1, wherein the method further comprises causing a confirmation display to be presented based on an indication received from a remote source that the payment transaction was successfully completed.

19. The device of claim 1, wherein the method further comprises causing one or more indications that a transaction was completed to be output through at least one output device to an affiliated third-party revenue tracking service.

20. The device of claim 1, further wherein the first remote source, the second remote source, or both comprise one or more remote databases.

21. The device of claim 1, further wherein the first remote source and the second remote source are the same or different.

22. The device of claim 1, further wherein each of the one or more purchasable item listings represents one or more purchasable items stored in one or more remote databases, wherein the one or more remote databases are updated periodically or in real time.

23. The device of claim 1, further wherein each of the one or more purchasable item listings represents one or more purchasable items based on information that is associated on the first remote source with the one or more purchasable items.

24. The device of claim 1, further wherein each of the one or more purchasable item listings represents one or more purchasable tickets.

25. The device of claim 24, further wherein the one or more purchasable tickets comprise one or more of a purchasable event ticket, a purchasable concert ticket, a purchasable sports ticket, a purchasable theatre ticket, or a purchasable festival ticket.

26. A computer-implemented method for enabling purchase of one or more purchasable items on a computing device, the method comprising:
causing, using one or more processors, an operating system of the computing device to generate a first user interface comprising one or more purchasable item listings, the one or more purchasable item listings being received through at least one input device by the computing device from a first remote source;
causing, using one or more processors, a single host application stored on the computing device to display the first user interface comprising the one or more purchasable item listings on at least one display on at least one presentation component;
generating, using one or more processors, and based at least in part on a user selection of one of the one or more purchasable item listings, a second user interface comprising a purchase and/or payment web page having one or more input fields, the purchase and/or payment web page being received through at least one output device by the computing device from a second remote source;
causing, using one or more processors, the single host application stored on the computing device to display the second user interface comprising the purchase and/or payment web page on at least one display on the at least one presentation component; and
causing, using one or more processors, a payment transaction to proceed based on purchase and/or payment information input into the one or more input fields.

27. The computer-implemented method of claim 26, further comprising receiving, through the at least one input device, the one or more purchasable item listings from the first remote source.

28. The computer-implemented method of claim 26, further comprising displaying, on the at least one presentation component, the first user interface comprising one or more purchasable item listings.

29. The computer-implemented method of claim 26, further comprising displaying, on the at least one presentation component, the second user interface comprising the purchase and/or payment web page.

30. The computer-implemented method of claim 26, further comprising modifying, using one or more processors, the first user interface based on one or more display presets prior to causing the single host application to display the first user interface.

31. The computer-implemented method of claim 26, further comprising causing, using one or more processors, the single host application stored on the computing device to generate and display a plurality of additional user interfaces each comprising one or more purchasable item listings.

32. The computer-implemented method of claim 31, further wherein the plurality of additional user interfaces progressively narrow the one or more purchasable item listings based on sub-categories.

33. The computer-implemented method of claim 26, further wherein the payment transaction automatically is successfully completed if one or more transaction requirements are met.

34. The computer-implemented method of claim 26, further comprising causing, using one or more processors, the one or more purchasable item listings to be received by the computing device from the first remote source.

35. The computer-implemented method of claim 26, wherein causing the operating system of the computing device to generate the first user interface comprising one or more purchasable item listings comprises causing one or more views native to the operating system to generate the first user interface, generating one or more pointers to the first user interface, and providing the one or more pointers to the host application.

36. The computer-implemented method of claim 26, wherein causing the operating system of the computing device to generate the first user interface comprising one or more purchasable item listings comprises causing one or more views native to the operating system to generate the first user interface, generating one or more pointers to the first user interface, and making one or more callbacks to the host application, the one or more callbacks comprising the one or more pointers.

37. The computer-implemented method of claim 36, further comprising modifying, using one or more processors, the first user interface based on one or more display presets in the one or more callbacks.

38. The computer-implemented method of claim 26, further wherein the host application enables one or more functions that are different from enabling purchase of one or more purchasable items.

39. The computer-implemented method of claim 26, further comprising causing, using one or more processors, the purchase and/or payment web page to be received by the computing device from the second remote source.

40. The computer-implemented method of claim 26, further comprising providing one or more responses based on user input received as a result of a user interacting with the second user interface.

41. The computer-implemented method of claim 40, further wherein providing the one or more responses based on user input received as a result of a user interacting with the second user interface comprises:
receiving input;
generating a dummy script based on the received input;
providing the dummy script to one or more native views, thereby causing the one or more native views to generate an additional user interface comprising one or more predetermined messages; and
causing the host application to display the additional user interface comprising the one or more predetermined messages on the at least one display on the at least one presentation component.

42. The computer-implemented method of claim 41, wherein the input comprises input received as a result of user interaction, input received as a result of one or more web pages being loaded, input received as a result of the payment transaction being successfully completed, or input received as a result of the payment transaction failing to be successfully completed.

43. The computer-implemented method of claim 40, further wherein providing the one or more responses based on user input received as a result of a user interacting with the second user interface comprises:
receiving input;
converting the received input into a format intelligible to the host application; and
providing the host application with the received input in the format intelligible to the host application.

44. The computer-implemented method of claim 43, further wherein providing the host application with the received input in the format intelligible to the host application comprises making one or more callbacks to the host application, the one or more callbacks containing the received input in the format intelligible to the host application.

45. The computer-implemented method of claim 26, wherein causing the payment transaction to proceed comprises causing the purchase and/or payment information to be output through at least one output device to a remote source configured to conduct the payment transaction.

46. The computer-implemented method of claim 26, further comprising causing a confirmation display to be presented based on an indication received from a remote source that the payment transaction was successfully completed.

47. The computer-implemented method of claim 26, further comprising causing one or more indications that a transaction was completed to be output through at least one output device to an affiliated third-party revenue tracking service.

48. The computer-implemented method of claim 26, further wherein the first remote source, the second remote source, or both comprise one or more remote databases.

49. The computer-implemented method of claim 26, further wherein the first remote source and the second remote source are the same or different.

50. The computer-implemented method of claim 26, further wherein each of the one or more purchasable item listings represents one or more purchasable items stored in one or more remote databases, wherein the one or more remote databases are updated periodically or in real time.

51. The computer-implemented method of claim 26, further wherein each of the one or more purchasable item listings represents one or more purchasable items based on information that is associated on the first remote source with the one or more purchasable items.

52. The computer-implemented method of claim 26, further wherein each of the one or more purchasable item listings represents one or more purchasable tickets.

53. The computer-implemented method of claim 26, further wherein the one or more purchasable tickets comprise one or more of a purchasable event ticket, a purchasable concert ticket, a purchasable sports ticket, a purchasable theatre ticket, or a purchasable festival ticket.

54. A computer-implemented system, comprising:
at least one processor;
at least one input device;
at least one presentation component;
at least one non-transitory computer readable storage device;
wherein the at least one non-transitory computer readable storage device contains instructions stored thereon that, when executed, cause the at least one processor to:
cause an operating system stored on the at least one non-transitory computer readable storage device to generate a first user interface comprising one or more purchasable item listings, the one or more purchasable item listings being received from a first remote source through the at least one input device;
cause a single host application stored on the at least one non-transitory computer readable storage device to display the first user interface comprising the one or more purchasable item listings on at least one display on the at least one presentation component;
generate, based at least in part on a user selection of one of the one or more purchasable item listings, a second user interface comprising a purchase and/or payment web page having one or more input fields, the purchase and/or payment web page being received from a second remote source through the at least one input device;
cause the single host application to display the second user interface comprising the purchase and/or payment web page on at least one display on the at least one presentation component; and
cause a payment transaction to proceed based on purchase and/or payment information input into the one or more input fields.
